(19) United States
(12) Patent Application Publication
(10) Pub. No.: US 2025/0236126 A1
(43) Pub. Date: Jul. 24, 2025

(54) PRINTING CASSETTE HAVING FIRST GUIDE AND SECOND GUIDE ARRANGED IN SKEWED RELATIONSHIP FOR ALTERING FIRST AND SECOND COMPONENTS OF TAPE CONVEYING DIRECTION

(71) Applicant: BROTHER KOGYO KABUSHIKI KAISHA, Nagoya (JP)

(72) Inventor: Kosuke HIGASHI, Nagoya (JP)

(21) Appl. No.: 19/174,485

(22) Filed: Apr. 9, 2025

Related U.S. Application Data
(63) Continuation of application No. PCT/JP2023/035646, filed on Sep. 29, 2023.

(30) Foreign Application Priority Data
Oct. 11, 2022 (JP) 2022-163373

(51) Int. Cl. B41J 15/04; B41J 3/407; B41J 11/04; B41J 17/32

(52) U.S. Cl. CPC B41J 15/046; B41J 3/4075; B41J 11/04; B41J 15/044; B41J 17/32

(57) ABSTRACT

A printing cassette includes: a tape roll and a case. The case includes: a first guide arranged at the same position as the tape roll in a first direction; and a second guide arranged at a different position from the tape roll in the first direction. The first guide has a first guide surface whose shape is defined by a part of an outer circumferential surface of a virtual first circular or elliptical column each having a first central axis inclined relative to the first direction. The second guide has a second guide surface whose shape is defined by a part of an outer circumferential surface of a virtual second circular or elliptical column each having a second central axis inclined relative to the first direction. The second central axis is not on the same virtual plane as the first central axis is.

### REFERENCE TO RELATED APPLICATIONS

This application is a continuation application of International Application No. PCT/JP2023/035646 filed on Sep. 29, 2023, which claims priority from Japanese Patent Application No. 2022-163373 filed on Oct. 11, 2022. The entire contents of the above-mentioned earlier applications are incorporated herein by reference.

### BACKGROUND ART

In a printing device configured to perform printing on a printing tape, a printing cassette accommodating a printing tape can be attached to and detached from a printing device body. In such printing cassettes, conventionally there has been known a configuration where two guides are employed to alter a conveying direction of the printing tape.

### SUMMARY

In the printing cassette described above, in order to alter a conveying path for the printing tape in both an axial direction of a tape roll and a direction orthogonal to the axial direction, a winding angle (i.e., a winding range) of the printing tape relative to each guide must be expanded. Hence, a frictional resistance generated while the printing tape is conveyed is likely to increase.

In view of the foregoing, it is an object of the present disclosure to provide a printing cassette capable of suppressing frictional resistance of the tape at a guide serving to alter the conveying direction.

In order to attain the above and other object, according to one aspect, the present disclosure provides a printing cassette including: a tape roll including a tape to be used for printing, the tape being wound about an axis parallel to a first direction; and a case that accommodates the tape roll.

The case includes a first guide and a second guide. At least a part of the first guide is arranged at the same position as the tape roll in the first direction, and the first guide is configured to guide the tape drawn off the tape roll to alter both a first component and a second component of a conveying direction of the tape, the first component being parallel to the first direction and the second component being orthogonal to the first direction. The second guide is arranged at a different position from the tape roll in the first direction. The second guide is configured to guide the tape guided by the first guide to alter both the first component and the second component of the conveying direction.

The first guide has a first guide surface whose shape is defined by a part of an outer circumferential surface of a virtual first circular column or a virtual first elliptical column each having a first central axis inclined relative to the first direction. The second guide has a second guide surface whose shape is defined by a part of an outer circumferential surface of a virtual second circular column or a virtual second elliptical column each having a second central axis inclined relative to the first direction. The second central axis is not on the same virtual plane as the first central axis is.

With this structure, since the first central axis and the second central axis are in a skewed relationship, a winding range of the tape over each of the first guide and second guide can be reduced. Hence, a frictional resistance to be generated on the conveyed tape can be reduced. As a result, the drive force required for conveying the tape can be reduced.

### BRIEF DESCRIPTION OF DRAWINGS

FIG. 1 is a schematic perspective view illustrating a printing device according to one embodiment.

FIG. 2A is a schematic top view illustrating a printing device body of the printing device of FIG. 1.

FIG. 2B is a schematic perspective view illustrating the printing device body of FIG. 2A.

FIG. 3A is a schematic perspective view of a printing cassette in the printing device of FIG. 1.

FIG. 3B is another schematic perspective view of the printing cassette in the printing device of FIG. 1.

FIG. 4 is an exploded schematic perspective view of the printing cassette of FIG. 3A.

FIG. 5 is a schematic plan view illustrating an internal structure of a first frame part of the printing cassette of FIG. 3A.

FIG. 6 is a schematic perspective view illustrating an internal structure of a second frame part of the printing cassette of FIG. 3A.

FIG. 7A is a schematic cross-sectional view taken along a line VIIA-VIIA in FIG. 3A.

FIG. 7B is a schematic cross-sectional view taken along a line VIIB-VIIB in FIG. 7A.

FIG. 7C is a schematic cross-sectional view taken along a line VIIC-VIIC in FIG. 7B.

FIG. 7D is a schematic cross-sectional view taken along a line VIID-VIID in FIG. 7C.

FIGS. 8A, 8B, 8C, 8D and 8E are schematic views for explaining an arrangement of a first guide and a second guide.

FIGS. 9A, 9B, 9C, 9D and 9E are schematic views for explaining another arrangement of the first guide and the second guide.

FIGS. 10A, 10B, 10C, 10D and 10E are schematic views for explaining still another arrangement of the first guide and the second guide.

FIGS. 11A and 11B are schematic perspective views of a printing cassette according to a different embodiment from the printing cassette of FIG. 3A.

FIG. 12A is a schematic perspective view of the printing cassette according to the different embodiment from the printing cassette of FIG. 3A in a state where a second cover part is removed.

FIG. 12B is a schematic plan view of the printing cassette of FIG. 12A.

FIG. 12C is a schematic perspective view of the printing cassette of FIG. 12A in a state where a first cover part is removed.

FIG. 12D is a schematic bottom view of the printing cassette of FIG. 12C.

FIG. 13A is a schematic perspective view of the printing cassette according to another different embodiment from the printing cassette of FIG. 3A in a state where the second cover part is removed.

FIG. 13B is a schematic plan view of the printing cassette of FIG. 13A.

FIG. 13C is a schematic perspective view of the printing cassette of FIG. 13A in a state where the first cover part is removed.

FIG. 13D is a schematic bottom view of the printing cassette of FIG. 13C.

### DESCRIPTION

### 1. First Embodiment

### 1-1. Configuration

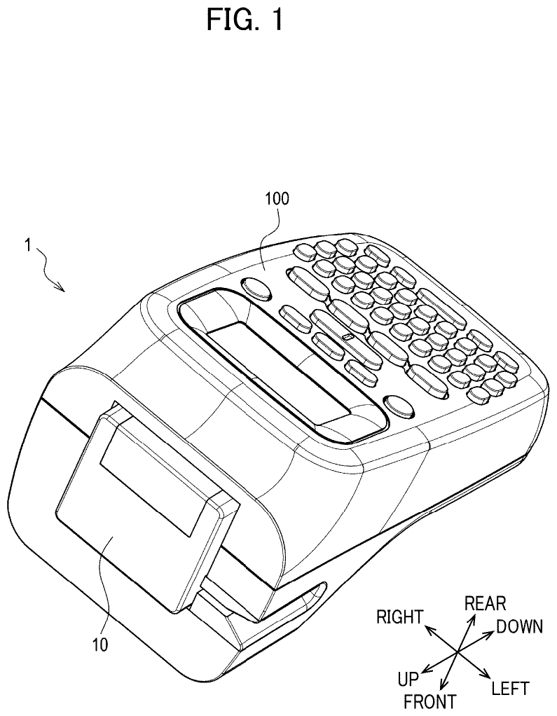

A printing device 1 illustrated in FIG. 1 includes a printing cassette 10, and a printing device body 100. The printing device 1 is a device configured to perform printing on a printing tape 11A.

In the present embodiment, a direction parallel to an axis L of a printing tape roll 11 will be called an up-down direction (a first direction); and, among directions orthogonal to the up-down direction, a direction parallel to a direction in which the printing tape 11A is to be discharged through a discharge opening 32C will be called a left-right direction, and a direction orthogonal to both the up-down direction and the left-right direction will be called a front-rear direction.

### Printing Device Body

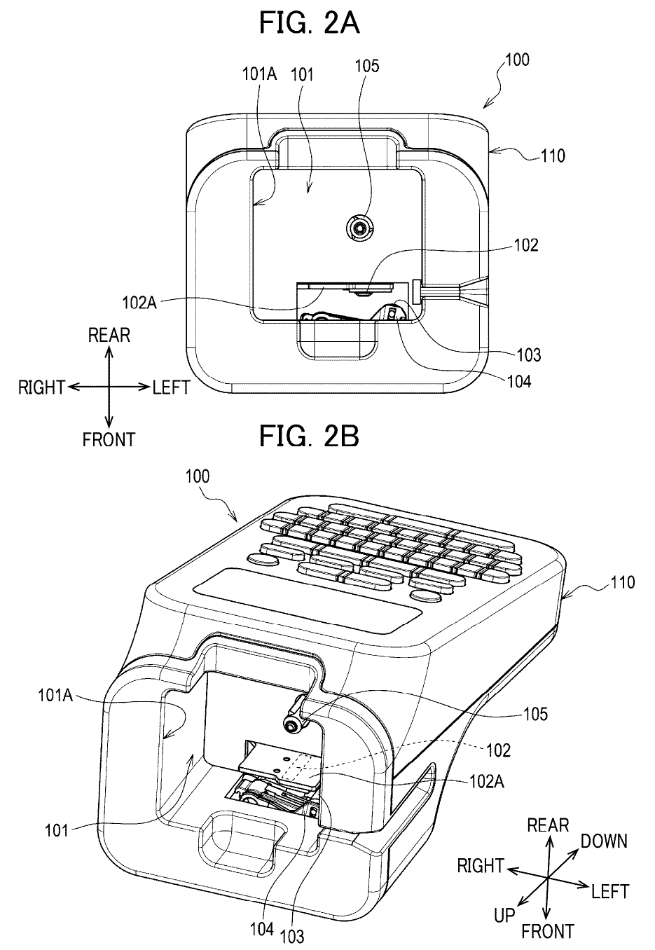

As illustrated in FIGS. 2A and 2B, the printing device body 100 includes a cassette accommodation part 101, a print head 102, a platen roller 103, a roller holder 104, a drive shaft 105, and a housing 110.

### Cassette Accommodation Part

The cassette accommodation part 101 is a recess to which the printing cassette 10 is to be attached. The cassette accommodation part 101 has a function for positioning of the printing cassette 10.

The cassette accommodation part 101 has an opening 101A formed in the housing 110. The printing cassette 10 is inserted through the opening 101A to be accommodated inside the cassette accommodation part 101.

### Print Head

The print head 102 is arranged inside the cassette accommodation part 101. The print head 102 has a plurality of heat-generating elements whose heating is to be individually controlled.

### Platen Roller

The platen roller 103 is arranged, inside the cassette accommodation part 101, near the print head 102 so as to oppose the print head 102. The platen roller 103 is pivotable in directions toward and away from the print head 102. A rotational axis of the platen roller 103 is parallel to the up-down direction.

A platen gear (not illustrated) configured to engage with an output gear 21 of the printing cassette 10 is coupled to the platen roller 103. The platen gear is pivotable together with the platen roller 103.

### Roller Holder

The roller holder 104 holds the platen roller 103. The roller holder 104 is mounted in the housing 110 such that the roller holder 104 is pivotable relative to the housing 110 in the front-rear direction.

### Drive Shaft

The drive shaft 105 is to be inserted into a take-up spool 16 and an input gear 22 of the printing cassette 10. The drive shaft 105 inputs a drive force into the printing cassette 10 for rotating the take-up spool 16 and input gear 22.

The drive shaft 105 is arranged inside the cassette accommodation part 101. A rotational axis of the drive shaft 105 is parallel to the up-down direction. The drive shaft 105 is rotatable about the rotational axis by a drive source (not illustrated) configured by a combination of a motor and gears, for example.

### Printing Cassette

The printing cassette 10 accommodates the printing tape 11A. The printing cassette 10 can be attached to and detached from the printing device body 100. Replacement of the printing cassette 10 can realize replenishment of the printing tape 11A and change of the type (such as size, color, and material) of printing tape 11A.

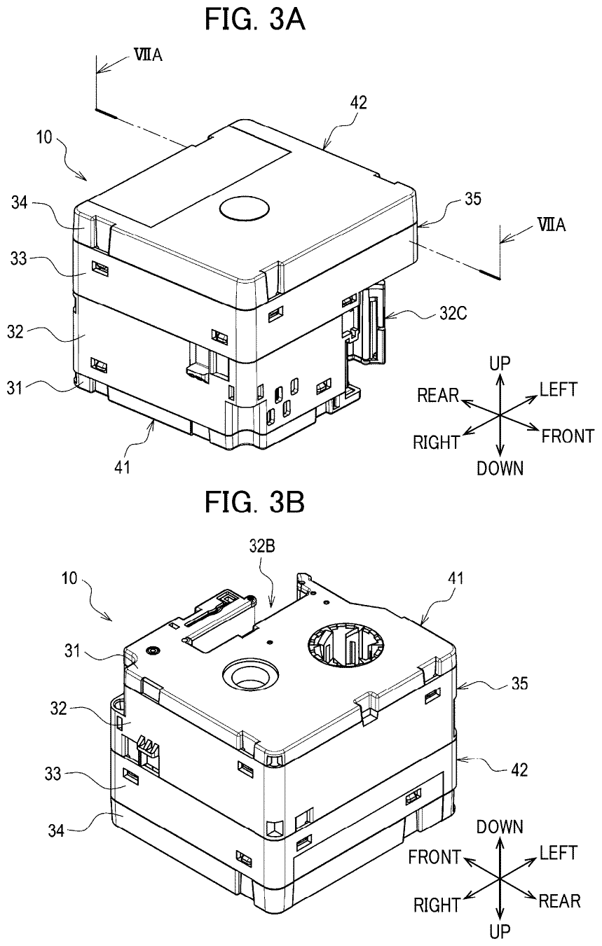

As illustrated in FIGS. 3A and 3B, the printing cassette 10 includes a main case 35 that accommodates therein at least a part of the printing tape 11A and at least a part of an ink ribbon 14A (that is, an auxiliary tape)

The main case 35 has a first case 41 and a second case 42. Each of the first case 41 and second case 42 is a rectangular parallelepiped having sides that are parallel to the up-down direction, sides that are parallel to the front-rear direction, and sides that are parallel to the left-right direction. In other words, the main case 35 has a rectangular outer shape when viewed in the up-down direction.

The first case 41 is connected to the second case 42 so as to protrude downward from a bottom surface of the second case 42. The main case 35 can be inserted into the cassette accommodation part 101 in such an orientation that the first case 41 faces toward a bottom surface of the cassette accommodation part 101.

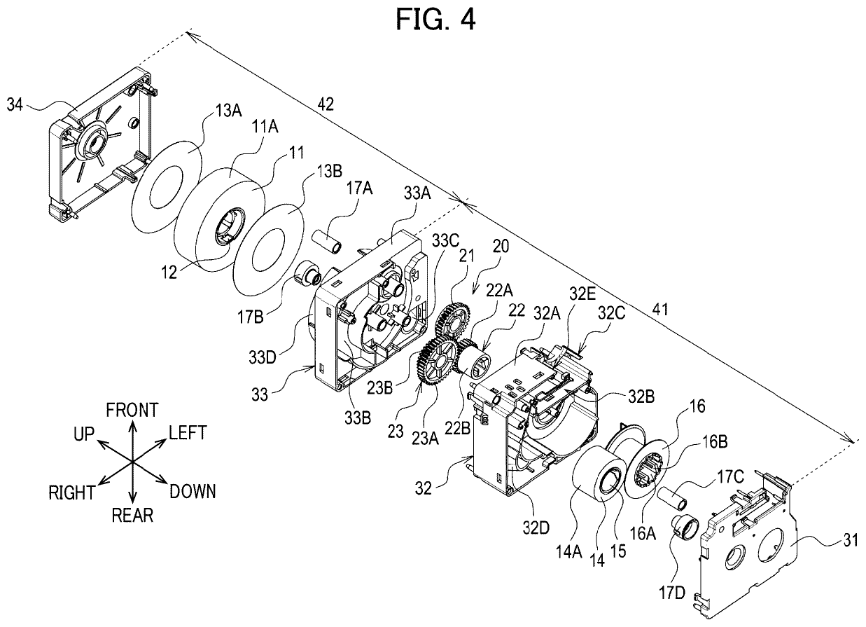

As illustrated in FIG. 4, the printing cassette 10 includes the printing tape roll 11, a first supply spool 12, an auxiliary tape roll 14, a second supply spool 15, the take-up spool 16, and a drive transmission mechanism 20.

### Printing Tape Roll

The printing tape roll 11 includes a strip of the printing tape 11A to be used for printing, the printing tape 11A being wound over the first supply spool 12 about the axis L of the printing tape roll 11. On a surface of the printing tape 11A, printing is performed using the print head 102 of the printing device body 100 and the ink ribbon 14A. The axis L of the printing tape roll 11 is parallel to the up-down direction.

Two spacer films 13A and 13B are arranged on respective outer sides of the printing tape roll 11 in the up-down direction such that the printing tape roll 11 is interposed between the spacer films 13A and 13B. The spacer films 13A and 13B are arranged between the printing tape roll 11 and a second cover part 34 and between the printing tape roll 11 and a second frame part 33, respectively. The printing tape 11A drawn off the printing tape roll 11 is guided by a first roller 17A and a second roller 17C.

### First Supply Spool

The first supply spool 12 is rotatable about a rotational axis parallel to the up-down direction. The first supply spool 12 supplies the printing tape 11A to the print head 102 by rotating as the platen roller 103 of the printing device body 100 conveys the printing tape 11A.

The rotational axis of the first supply spool 12 is coincident with the axis L of the printing tape roll 11. A rotational resistance is applied to the first supply spool 12 by a clutch spring held in a first clutch spring holder 17B.

### Auxiliary Tape Roll

The auxiliary tape roll 14 includes a strip of the ink ribbon 14A to be used for printing on the printing tape 11A, the ink ribbon 14A being wound over the second supply spool 15 about an axis of the auxiliary tape roll 14.

The ink ribbon 14A is overlaid on the printing tape 11A within a head opening 32B and is to be used for printing by the print head 102. After being used for printing, the ink ribbon 14A is taken up on the take-up spool 16.

In the up-down direction, the auxiliary tape roll 14 is arranged at a different position from (specifically, lower than) the printing tape roll 11. Further, at least a part of the auxiliary tape roll 14 is arranged to overlap the printing tape roll 11 in the up-down direction.

### Second Supply Spool

The second supply spool 15 is rotatable about a rotational axis thereof. The rotational axis of the second supply spool 15 is parallel to the up-down direction.

The second supply spool 15 supplies the ink ribbon 14A to the print head 102 by rotating as the take-up spool 16 takes up the ink ribbon 14A. A rotational resistance is applied to the second supply spool 15 by a clutch spring held in a second clutch spring holder 17D.

### Take-Up Spool

The take-up spool 16 is rotatable about a rotational axis thereof. The rotational axis of the take-up spool 16 is parallel to the rotational axis of the second supply spool 15.

The take-up spool 16 is cylindrical and has a hollow area defined by an inner circumferential surface 16A. Splines 16B are provided at the inner circumferential surface 16A of the take-up spool 16. The drive shaft 105 of the printing device body 100 is configured to be coupled with the splines 16B. The take-up spool 16 takes up the ink ribbon 14A when rotated by the drive shaft 105.

### Drive Transmission Mechanism

The drive transmission mechanism 20 transmits a drive force from the drive shaft 105 to the platen roller 103 when the printing cassette 10 is attached to the printing device body 100. The drive transmission mechanism 20 includes the output gear 21, the input gear 22, and an idle gear 23.

The printing tape roll 11, drive transmission mechanism 20, and take-up spool 16 are arranged in the up-down direction in an order of the printing tape roll 11, drive transmission mechanism 20, and take-up spool 16.

### Output Gear

The output gear 21 is an external gear for externally outputting the drive force to be used for conveying the printing tape 11A. Specifically, the output gear 21 transmits the drive force to the platen gear of the printing device body 100.

A rotational axis of the output gear 21 is parallel to the rotational axis of the second supply spool 15. The output gear 21 is partially exposed in a space communicating with the head opening 32B. The output gear 21 engages with the platen gear in the space communicating with the head opening 32B in a state where the printing cassette 10 is attached to the printing device body 100 (i.e., in a state where the main case 35 is accommodated in the cassette accommodation part 101).

### Input Gear

The input gear 22 is indirectly engaged with the output gear 21 via the idle gear 23 and transmits the drive force to the output gear 21.

The input gear 22 has an external gear 22A, and a spool 22B. The spool 22B is a cylindrical internal gear with spines provided on an inner circumferential surface thereof. The spool 22B is fixed to one side surface of the external gear 22A. The external gear 22A is rotatable together with the spool 22B by the drive force inputted into the spool 22B. A rotational axis of the input gear 22 (i.e., rotational axes of the external gear 22A and spool 22B) is arranged colinear with the rotational axis of the take-up spool 16.

The rotational axis of the input gear 22 overlaps the hollow area in the take-up spool 16 in the up-down direction. Accordingly, the drive shaft 105 is simultaneously inserted in the take-up spool 16 and the input gear 22 in the state where the printing cassette 10 is attached to the printing device body 100. As a result, the input gear 22, although not directly coupled with the take-up spool 16, is rotated together with the take-up spool 16 by the drive shaft 105.

### Idle Gear

The idle gear 23 is drivingly connected to (i.e., engaged with) the input gear 22 and output gear 21 and transmits the drive force inputted into the input gear 22 to the output gear 21.

The idle gear 23 is a stepped gear configured of an upstream gear 23A engaged with the input gear 22, and a downstream gear 23B engaged with the output gear 21. The upstream gear 23A and downstream gear 23B are arranged coaxially with each other. The downstream gear 23B has a smaller diameter than the upstream gear 23A. Further, in the up-down direction, the downstream gear 23B is arranged closer to (i.e., upward of) the printing tape roll 11 than the upstream gear 23A is to the printing tape roll 11.

The idle gear 23 transmits the drive force to the output gear 21 while reducing a rotational speed of the drive force inputted into the input gear 2. That is, the drive transmission mechanism 20 includes a reduction mechanism whose reduction ratio is a transmission ratio obtained by dividing a rotational speed of the input gear 22 by a rotational speed of the output gear 21.

### Case

The main case 35 has a first cover part 31, a first frame part 32, the second frame part 33, the second cover part 34, the first roller 17A, and the second roller 17C.

The first cover part 31 constitutes a bottom end portion of the printing cassette 10. The first frame part 32 is arranged above the first cover part 31 and is coupled to the first cover part 31 in the up-down direction. The second frame part 33 is arranged above the first frame part 32 and is coupled to the first frame part 32 in the up-down direction. The second cover part 34 constitutes a top end portion of the printing cassette 10. The second cover part 34 is coupled to the second frame part 33 in the up-down direction.

The first cover part 31, first frame part 32, and a portion of the second frame part 33 constitute the first case 41, which houses therein the auxiliary tape roll 14, second supply spool 15, take-up spool 16, and drive transmission mechanism 20. In the up-down direction, the first case 41 is arranged at a different position from (specifically, lower than) the printing tape roll 11.

The auxiliary tape roll 14, second supply spool 15, and take-up spool 16 are arranged in a space enclosed by the first cover part 31 and first frame part 32. The drive transmission mechanism 20 is arranged in a space enclosed by the first frame part 32 and second frame part 33. In other words, the drive transmission mechanism 20 is arranged between the printing tape roll 11 and the auxiliary tape roll 14 in the up-down direction.

The second cover part 34 and second frame part 33 constitute the second case 42 that houses the printing tape roll 11 therein. In other words, the printing tape roll 11 is arranged in a space enclosed by the second cover part 34 and second frame part 33.

The first frame part 32 has a first side wall 32A, the head opening 32B, the discharge opening 32C, a second guide 32D, and a drawn-out part 32E. The first side wall 32A constitutes outer side surfaces of the main case 35 that are parallel to the up-down direction.

The head opening 32B is a part that is cut out from the first side wall 32A. The head opening 32B overlaps the second guide 32D in a direction orthogonal to a radial direction of the printing tape roll 11 (i.e., a direction orthogonal to the up-down direction).

The head opening 32B is a space in which the print head 102 and a holding member 102A holding the print head 102 are positioned in the state where the printing cassette 10 is attached to the printing device body 100. In other words, the head opening 32B is configured of a printing space in which printing is performed, and a recess that communicates with the printing space in the left-right direction.

In the head opening 32B, printing on the printing tape 11A by the print head 102 is performed. The head opening 32B is open on the bottom of the printing cassette 10 so that the print head 102 can be inserted into the head opening 32B from below.

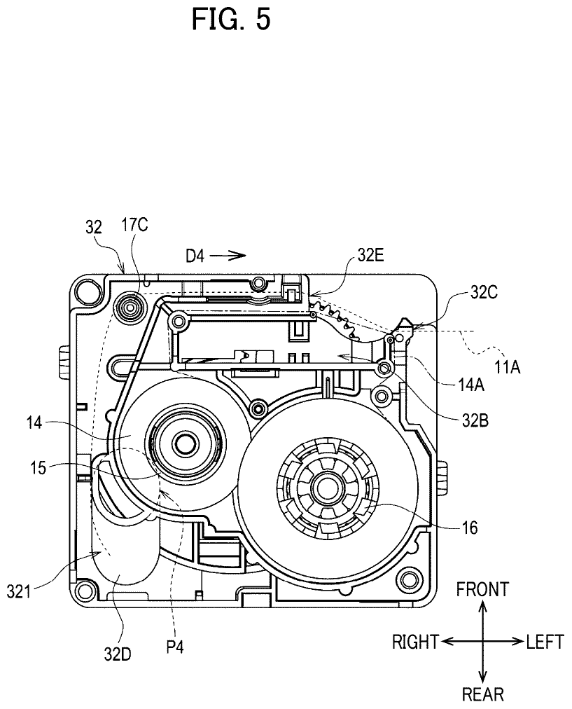

As illustrated in FIG. 5, the printing tape 11A and the ink ribbon 14A are spanned in the left-right direction across a leftward region of the head opening 32B. In the head opening 32B, the printing tape 11A is overlaid on the ink ribbon 14A and is exposed outside the main case 35. After printing is performed, the printing tape 11A is to be discharged out of the printing device 1 through the discharge opening 32C. A direction in which the printing tape 11A is to be discharged at the discharge opening 32C is leftward.

The second guide 32D is constituted by a part of a circular column or cylinder. That is, the second guide 32D has a second guide surface 321 whose shape is defined by a part of an outer circumferential surface of a virtual second circular column P4. The second guide 32D is arranged inside the first side wall 32A on a conveying path of the printing tape 11A in the first case 41.

The second guide 32D is integrally molded together with the first side wall 32A (an example of “case body”), thereby being fixed to the first side wall 32A. The first side wall 32A supports the second guide 32D such that the second guide 32D does not move nor rotate.

The second guide 32D is arranged between the auxiliary tape roll 14 and the first side wall 32A. The second guide 32D overlaps the auxiliary tape roll 14 in a radial direction of the auxiliary tape roll 14. In other words, the second guide 32D is arranged at a different position from the printing tape roll 11 in the up-down direction and is at the same position as the auxiliary tape roll 14 in the up-down direction.

The second guide 32D guides the printing tape 11A to alter both a first component and a second component of a conveying direction of the printing tape 11A. The first component is a component parallel to the up-down direction, and the second component is a component orthogonal to the up-down direction.

Specifically, relative to the printing tape 11A guided by a first guide 33C, the second guide 32D eliminates the first component (i.e., a downward component) and alters the second component from rightward to forward.

After being guided by the first roller 17A and the first guide 33C inside the second case 42, the printing tape 11A is conveyed into the first case 41 while being guided by the second guide 32D.

The second roller 17C (an example of “fourth guide”) is arranged between the second guide 32D and the drawn-out part 32E on the conveying path of the printing tape 11A.

The second roller 17C is arranged at a different position from the printing tape roll 11 in the up-down direction. Further, the second roller 17C is arranged at the same position as the second guide 32D in the up-down direction. The second roller 17C is constituted by a rotatable circular column or cylinder. That is, an outer circumferential surface of the second roller 17C constitutes a fourth guide surface whose shape is defined by a part of an outer circumferential surface of a virtual fourth circular column having a fourth central axis (i.e., a rotational axis of the second roller 17C) parallel to the up-down direction.

The second roller 17C guides the printing tape 11A to alter only the second component orthogonal to the up-down direction in the conveying direction of the printing tape 11A guided by the second guide 32D. A fourth conveying direction D4 of the printing tape 11A, which is a direction in which the printing tape 11A is to be conveyed in a region between the second roller 17C and the drawn-out part 32E (i.e., a region downstream of the second roller 17C), is leftward and is orthogonal to the up-down direction.

The second roller 17C rotates about an axis thereof as the printing tape 11A is conveyed. After being guided by the second guide 32D, the printing tape 11A is conveyed toward the drawn-out part 32E and discharge opening 32C while being guided by the second roller 17C.

The drawn-out part 32E is an opening through which the printing tape 11A is to be drawn out of the main case 35 by the platen roller 103 in a direction orthogonal to the up-down direction. The drawn-out part 32E is arranged at the same position as the second guide 32D in the up-down direction.

At the drawn-out part 32E, the printing tape 11A guided by the second guide 32D and second roller 17C is drawn out into the head opening 32B. The printing tape 11A drawn out through the drawn-out part 32E opposes the print head 102 of the printing device body 100 in a state where the main case 35 is attached to the printing device body 100.

The second frame part 33 illustrated in FIG. 4 has a second side wall 33A, a partitioning wall 33B, the first guide 33C, and a roll frame portion 33D. The second side wall 33A constitutes outer side surfaces of the main case 35 that are parallel to the up-down direction.

The partitioning wall 33B extends in the front-rear direction and left-right direction and has a surface orthogonal to the up-down direction. In the up-down direction, the partitioning wall 33B is arranged between the printing tape roll 11 and the drive transmission mechanism 20, that is, between the first supply spool 12 and the second guide 32D.

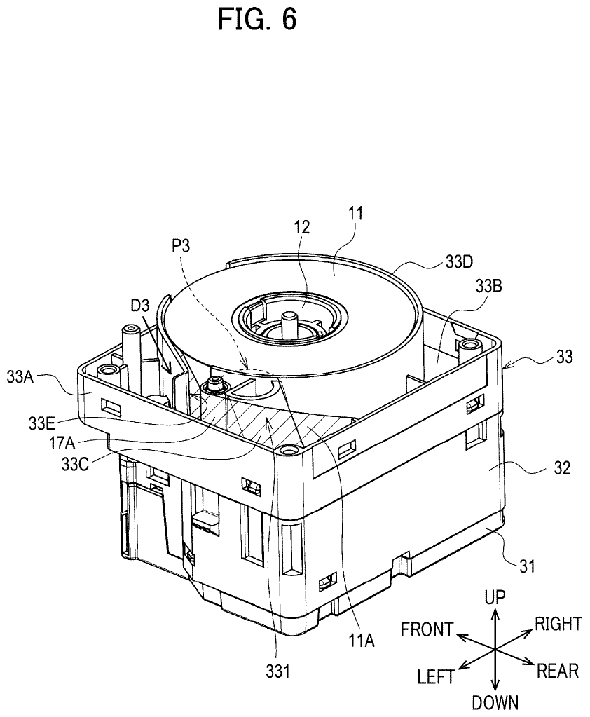

As illustrated in FIG. 6, the first guide 33C is constituted by a part of a circular column or cylinder. That is, the first guide 33C has a first guide surface 331 whose shape is defined by a part of an outer circumferential surface of a virtual first circular column P3. The first guide 33C is arranged inside the second side wall 33A on the conveying path of the printing tape 11A in the second case 42.

The first guide 33C is integrally molded together with the second side wall 33A (an example of “case body”) and the roll frame portion 33D, thereby being fixed to the second side wall 33A. The second side wall 33A supports the first guide 33C such that the first guide 33C does not move nor rotate.

The first guide 33C is arranged outside the roll frame portion 33D and overlaps the printing tape roll 11 in the radial direction of the same. In other words, at least a part of the first guide 33C is arranged at the same position as the printing tape roll 11 in the up-down direction.

The first guide 33C guides the printing tape 11A to alter both the first component and second component of the conveying direction of the printing tape 11A. The first component is a component parallel to the up-down direction, and the second component is a component orthogonal to the up-down direction.

Specifically, relative to the printing tape 11A drawn off the printing tape roll 11, the first guide 33C adds a downward component as the first component and alters the second component from rearward to rightward.

The first roller 17A (an example of “third guide”) is arranged between the printing tape roll 11 and the first guide 33C (i.e., near a point where the printing tape 11A is drawn off the printing tape roll 11) on the conveying path of the printing tape 11A.

At least a part of the first roller 17A is arranged at the same position as the printing tape roll 11 and first guide 33C in the up-down direction. The first roller 17A is constituted by a rotatable circular column or cylinder. In other words, an outer circumferential surface of the first roller 17A constitutes a third guide surface whose shape is defined by a part of an outer circumferential surface of a virtual third circular column having a third central axis (i.e., a rotational axis of the first roller 17A) parallel to the up-down direction.

The first roller 17A guides the printing tape 11A to alter only the second component orthogonal to the up-down direction in the conveying direction of the printing tape 11A drawn off the printing tape roll 11. A third conveying direction D3 of the printing tape 11A, which is a direction in which the printing tape 11A is to be conveyed in a region between the printing tape roll 11 and the first roller 17A (i.e., a region upstream of the first roller 17A), is orthogonal to the up-down direction.

The printing tape 11A is mounted over the first roller 17A at an upstream side of the first guide 33C. The first roller 17A rotates about an axis thereof as the printing tape 11A is conveyed. After being drawn off the printing tape roll 11 and guided by the first roller 17A, the printing tape 11A is conveyed into the first case 41, while being twisted, as being guided by the first guide 33C.

The roll frame portion 33D protrudes upward from the partitioning wall 33B. The roll frame portion 33D surrounds the printing tape roll 11 from radially outside thereof. The printing tape 11A is drawn off the printing tape roll 11 at an opening 33E in the roll frame

### Conveying Path of the Printing Tape

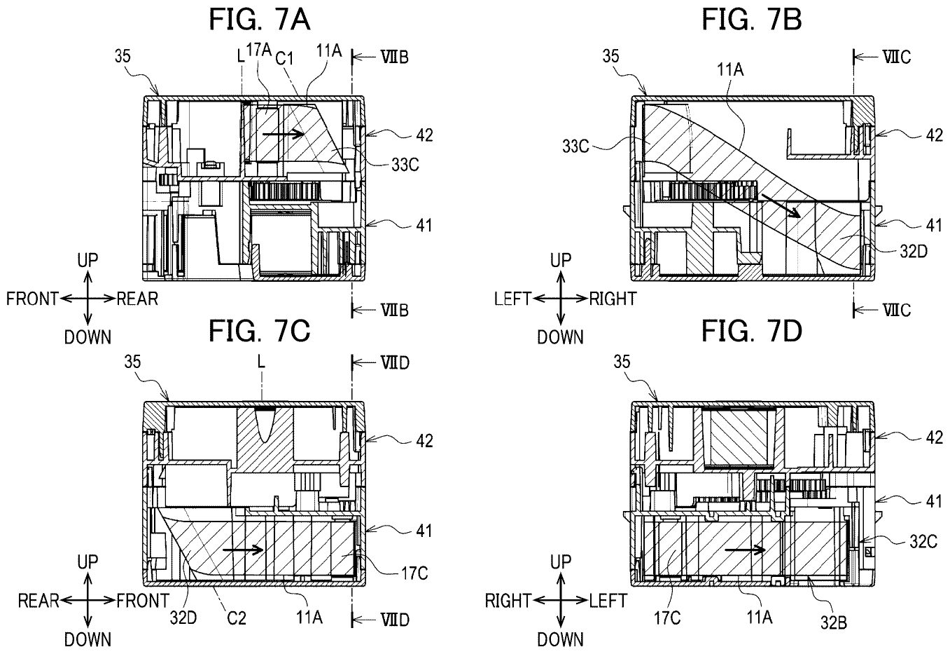

As illustrated in FIGS. 7A, 7B, 7C, and 7D, the first guide 33C and second guide 32D constitute the conveying path for conveying the printing tape 11A from the second case 42 into the first case 41.

Specifically, as illustrated in FIG. 7A, the printing tape 11A drawn off the printing tape roll 11 is conveyed downward and rearward while contacting the first guide 33C from radially outside of the printing tape roll 11.

After passing over the first guide 33C, the printing tape 11A is conveyed downward and rightward toward the second guide 32D, as illustrated in FIG. 7B. The printing tape 11A is mounted over the first guide 33C and second guide 32D in the order of the first guide 33C and second guide 32D. The twist added to the printing tape 11A by the first guide 33C is cancelled by the second guide 32D.

The printing tape 11A does not contact the main case 35 between the first guide 33C and second guide 32D. In other words, the main case 35 has no other guides arranged on the conveying path of the printing tape 11A between the first guide 33C and second guide 32D.

After reaching the second guide 32D, the printing tape 11A is conveyed forward while contacting the second guide 32D from outside thereof in the radial direction of the auxiliary tape roll 14, as illustrated in FIG. 7C.

After passing over the second guide 32D, the printing tape 11A is conveyed leftward while being guided by the second roller 17C, as illustrated in FIG. 7D. Thereafter, the printing tape 11A passes through the head opening 32B and is discharged through the discharge opening 32C.

### Arrangement of Guides

The first guide 33C and second guide 32D are respectively arranged at different corner portions of the main case 35. Specifically, the first guide 33C is disposed in a left rear corner portion of the main case 35, and the second guide 32D is disposed in a right rear corner portion of the main case 35.

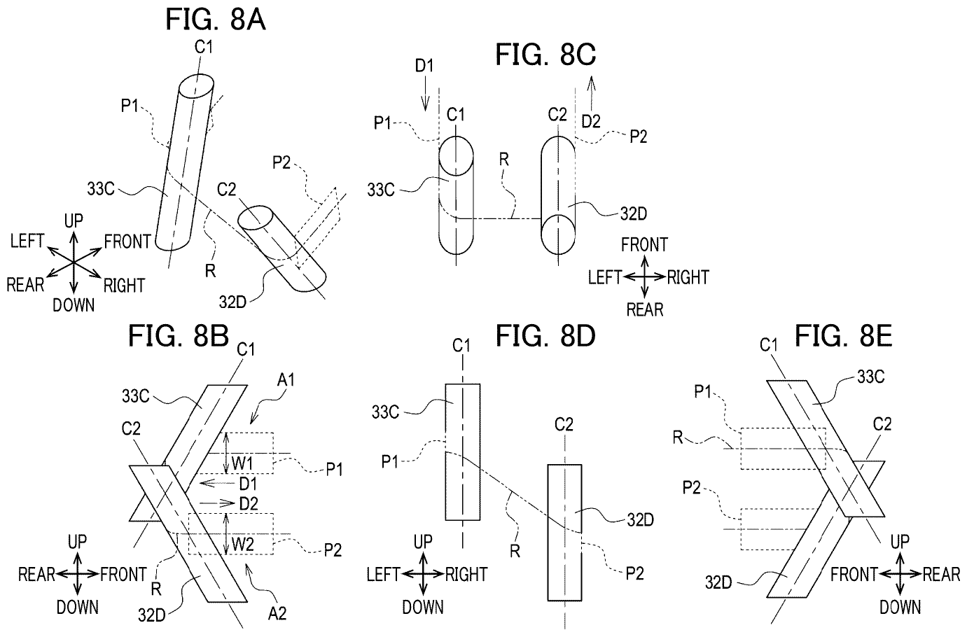

FIGS. 8A, 8B, 8C, 8D, and 8E schematically illustrate the arrangement of the first guide 33C and second guide 32D. In FIGS. 8A-8E, the first guide 33C and second guide 32D are schematically depicted as outer circumferential surfaces of circular columns. Further, a conveying path R representing a widthwise center of the printing tape 11A being conveyed is depicted with a two-dot chain line in each of FIGS. 8A-8E.

As illustrated in FIG. 8B, a first width direction W1 of the printing tape 11A in a first region A1 of the conveying path R is parallel to a second width direction W2 of the printing tape 11A in a second region A2 of the conveying path R.

The first region A1 is a region between the first roller 17A and first guide 33C and includes a region immediately before the first guide 33C. The second region A2 is a region between the second guide 32D and second roller 17C and includes a region immediately after the second guide 32D. In this embodiment, the first width direction W1 and second width direction W2 are parallel to the up-down direction.

At least a part of the second guide 32D is arranged at a different position from the first guide 33C in the up-down direction. According to the actual shapes in the present embodiment, an entirety of the second guide 32D is arranged at a different position from the first guide 33C in the up-down direction, as illustrated in FIG. 7B. However, as illustrated in FIGS. 8A-8E, the top of the second guide 32D may be located at the same position in the up-down direction as the first guide 33C.

A central axis C1 of the first guide 33C (i.e., a central axis of the circular column or cylinder constituting the first guide 33C, and a first central axis possessed by the virtual first circular column P3) is parallel to a first virtual plane P1 that includes both the first width direction W1 and a first conveying direction D1 of the printing tape 11A in the first region A1.

In other words, the central axis C1 of the first guide 33C is parallel to both the first width direction W1 and the first conveying direction D1. Further, within the first virtual plane P1, the central axis C1 of the first guide 33C is inclined relative to the first width direction W1 (i.e., the up-down direction).

A central axis C2 of the second guide 32D (i.e., a central axis of the circular column or cylinder constituting the second guide 32D, and a second central axis possessed by the virtual second circular column P4) is parallel to a second virtual plane P2 that includes the second width direction W2 and a second conveying direction D2 of the printing tape 11A in the second region A2.

In other words, the central axis C2 of the second guide 32D is parallel to both the second width direction W2 and the second conveying direction D2. Further, within the second virtual plane P2, the central axis C2 of the second guide 32D is inclined relative to the second width direction W2 (i.e., the up-down direction).

Further, the central axis C2 of the second guide 32D is not on the same virtual plane as the central axis C1 of the first guide 33C is. Specifically, the central axis C2 of the second guide 32D is in a skewed relationship with the central axis C1 of the first guide 33C.

When viewed in the up-down direction, a turning angle of the second conveying direction D2 relative to the first conveying direction D1 is no greater than 195 degrees. The “turning angle” is an angle of rotation (i.e., an amount of angular change) required to bring the first conveying direction D1 into alignment with the second conveying direction D2, and is the angle of rotation in a virtual plane that includes the first conveying direction D1 and second conveying direction D2 (i.e., orthogonal to the up-down direction).

A sum of a winding angle of the printing tape 11A over the first guide surface 331 of the first guide 33C in a circumferential direction of the virtual first circular column P3 (i.e., viewed in the axial direction of the first guide 33C) and a winding angle of the printing tape 11A over the second guide surface 321 of the second guide 32D in a circumferential direction of the virtual second circular column P4 (i.e., viewed in the axial direction of the second guide 32D) is 235 degrees or less.

In the present embodiment, the first conveying direction D1 is rearward and the second conveying direction D2 is frontward. Therefore, the first conveying direction D1 and second conveying direction D2 are parallel to each other. That is, the conveying path of the printing tape 11A is turned 180 degrees by the first guide 33C and the second guide 32D. Further, the first virtual plane P1 and the second virtual plane P2 are each orthogonal to the left-right direction.

As illustrated in FIG. 7A, the central axis C1 of the first guide 33C is sloped so as to separate from the axis L of the printing tape roll 11 as approaching the second guide 32D in the up-down direction (i.e., as extending downward). In other words, a lower part of the first guide 33C is positioned farther outward relative to an upper part thereof in the second case 42.

As illustrated in FIG. 7C, the central axis C2 of the second guide 32D is sloped so as to separate from the axis L of the printing tape roll 11 as approaching the first guide 33C in the up-down direction (i.e., as extending upward). In other words, an upper part of the second guide 32D is positioned farther outward relative to a lower part thereof in the first case 41.

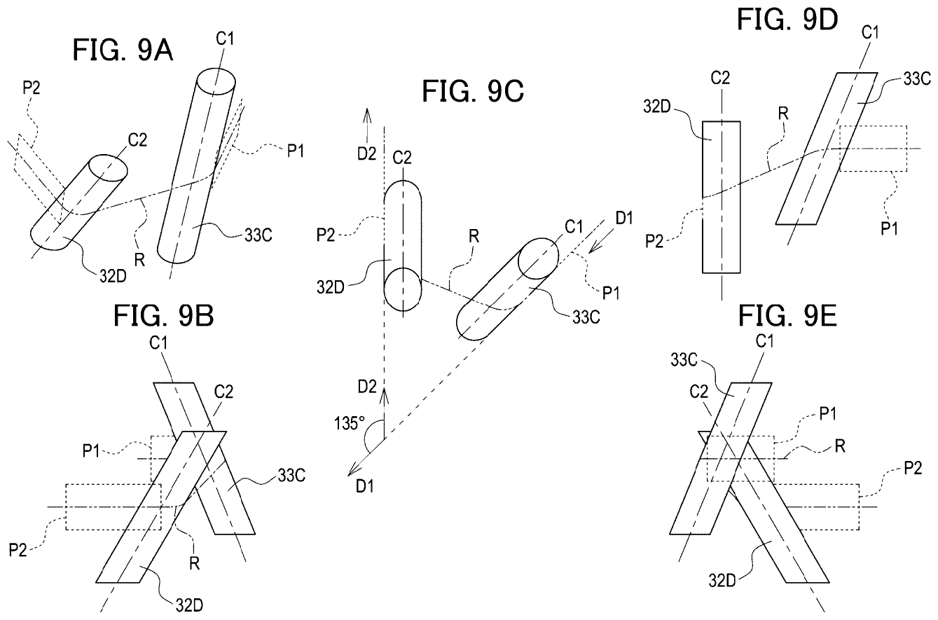

As illustrated in FIGS. 9A, 9B, 9C, 9D, and 9E, the second conveying direction D2 need not be parallel to the first conveying direction D1. In FIGS. 9A-9E, the conveying path R of the printing tape 11A is turned 135 degrees by the first guide 33C and second guide 32D (see FIG. 9C). In FIGS. 9A-9E, the first virtual plane P1 and second virtual plane P2 are not parallel to each other (i.e., cross each other).

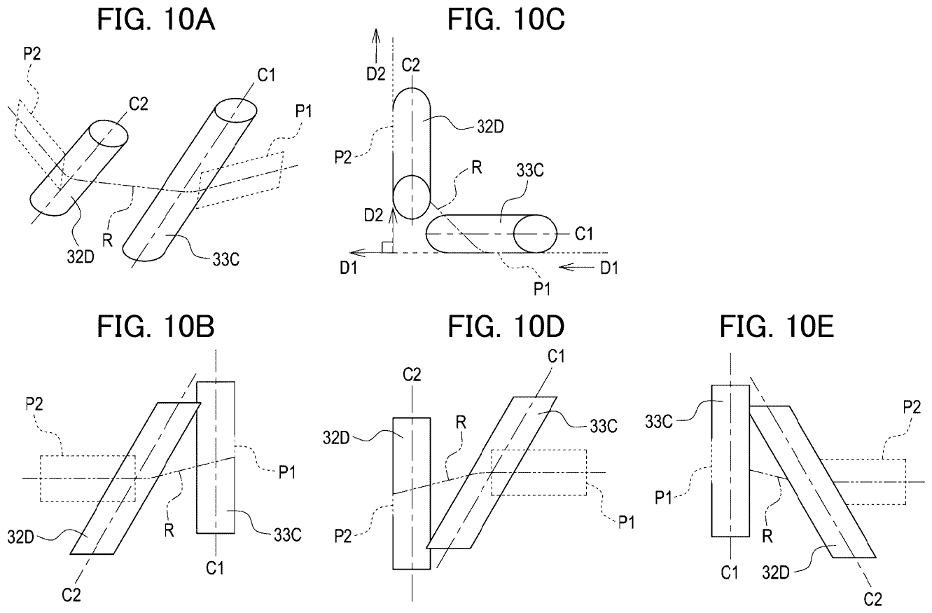

Alternatively, as illustrated in FIGS. 10A, 10B, 10C, 10D, and 10E, the conveying path R of the printing tape 11A may be turned 90 degrees by the first guide 33C and second guide 32D (see FIG. 10C). In FIGS. 10A-10E, the first virtual plane P1 and second virtual plane P2 are orthogonal to each other.

### Conveyance and Printing of Tape in the Printing Device Body

In a state where the printing cassette 10 is attached to the printing device body 100, the print head 102 is positioned to overlap the printing tape 11A and ink ribbon 14A in the front-rear direction in the head opening 32B.

The printing tape 11A is conveyed by the platen roller 103 to the head opening 32B and is pressed, through the ink ribbon 14A, against the print head 102 where the heat-generating elements are heated. Thus, some of the ink on the surface of the ink ribbon 14A is transferred onto the printing tape 11A to print characters, symbols, and the like on the printing tape 11A.

After printing is performed on the printing tape 11A, the platen roller 103 conveys the printing tape 11A from inside toward outside of the printing cassette 10 through the discharge opening 32C. The platen roller 103 is rotated by the platen gear, which is engaged with the output gear 21. The platen roller 103 is made pivotable, by the roller holder 104, between a position where the platen roller 103 is separated from the printing cassette 10 and a position where the platen gear is engaged with the output gear 21.

In the state where the main case 35 of the printing cassette 10 is inserted in the cassette accommodation part 101, the drive shaft 105 is engaged with the input gear 22 and the platen gear is engaged with the output gear 21.

Specifically, in a state where the drive shaft 105 is inserted in the take-up spool 16 and input gear 22 of the printing cassette 10, pivoting of the platen roller 103 toward the head opening 32B of the printing cassette 10 causes the platen gear to engage with the output gear 21.

The output gear 21 is rotated by rotation of the input gear 22 by the drive shaft 105 in the state where the printing cassette 10 is attached. Further, the platen gear rotates by the rotation of the output gear 21, thereby rotating the platen roller 103.

### 1-2. Advantages

The embodiment described above obtains the following advantages.
(1a) Since the central axis C1 of the first guide 33C and the central axis C2 of the second guide 32D are in a skewed relationship, the winding range of the printing tape 11A over each of the first guide 33C and second guide 32D can be reduced. Hence, a frictional resistance generated on the conveyed printing tape 11A can be reduced. As a result, the drive force required for conveying the printing tape 11A can be reduced.
(1b) By arranging the central axis C1 of the first guide 33C inclined within the first virtual plane P1 and the central axis C2 of the second guide 32D inclined within the second virtual plane P2, the printing tape 11A is less likely to be twisted in each of the first region A1 and second region A2.
(1c) By the first roller 17A, the printing tape 11A can be stably conveyed from the printing tape roll 11 to the first guide 33C. As a result, the drive force required for conveying the printing tape 11A can be further reduced.
(1d) By the second roller 17C, the printing tape 11A can be stably conveyed from the second guide 32D to the drawn-out part 32E. As a result, the drive force required for conveying the printing tape 11A can be further reduced.
(1e) By configuring the first guide 33C and second guide 32D fixed to the body of the main case 35, both the first guide 33C and second guide 32D can be molded integrally with the body of the main case 35.
(1f) By arranging the first guide 33C and second guide 32D in different corner portions of the main case 35, a distance between the first guide 33C and second guide 32D can be increased. As a result, twisting of the printing tape 11A can be further suppressed from occurring.

### 2. Second Embodiment

### 2-1. Configuration

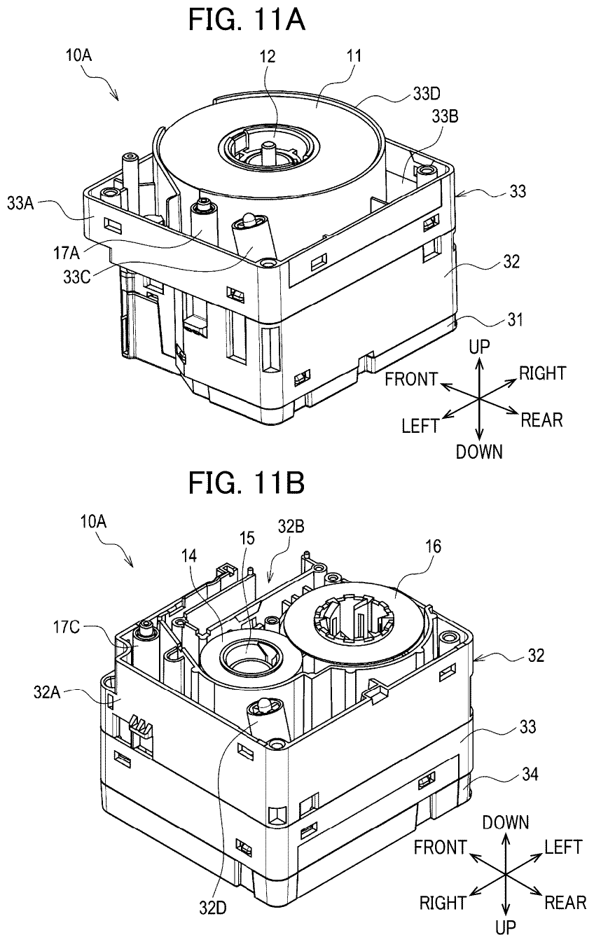

A printing cassette 10A illustrated in FIGS. 11A and 11B is to be attached to the printing device body 100 of FIG. 2A, in place of the printing cassette 10 according to the first embodiment illustrated in FIG. 3A.

In the printing cassette 10A, the first guide 33C and second guide 32D of the printing cassette 10 according to the first embodiment are respectively replaced with circular columnar or cylindrical rollers. The first guide 33C is rotatable about an axis thereof relative to the second side wall 33A. The second guide 32D is rotatable about an axis thereof relative to the first side wall 32A.

The arrangement of the first guide 33C and second guide 32D is identical to that in the printing cassette 10 according to the first embodiment. The first guide 33C and second guide 32D alter the conveying direction of the printing tape 11A while rotating about their axes.

### 2-2. Advantages

The embodiment described above can obtain the following advantages.
(2a) Since the first guide 33C and second guide 32D are rotatable about their axes, frictional resistance between these guides and printing tape 11A is reduced, thereby leading to reduction in the drive force for conveying the printing tape 11A.

### 3. Other Embodiments

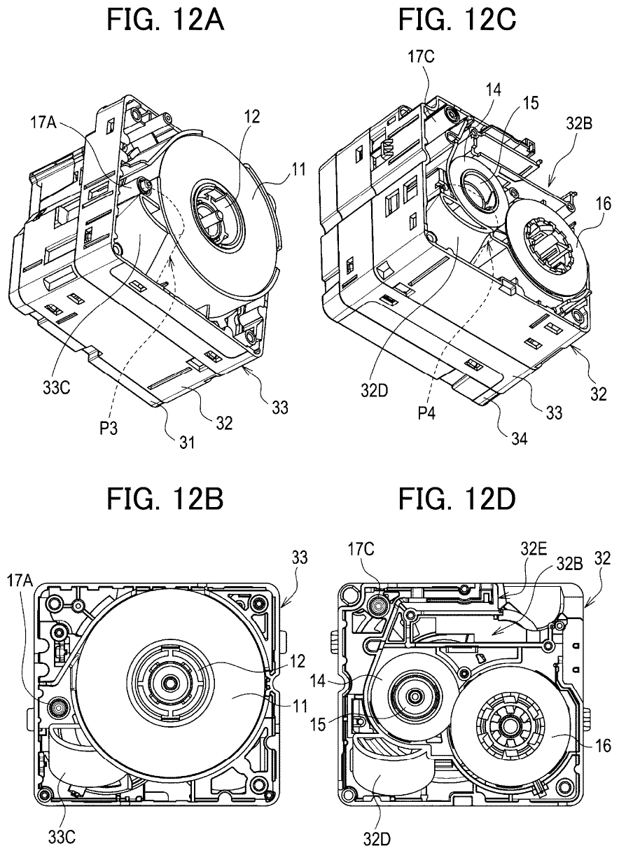

While the embodiments of the present disclosure are described above, it should be apparent that the present disclosure should not be limited to the above embodiments and can be embodied in various forms.
(3a) In the printing device according to the above embodiments, as illustrated in FIGS. 12A, 12B, 12C, and 12D, the guide surfaces of the first guide 33C and second guide 32D may be constituted each in a form of a part of an outer circumferential surface of a virtual first elliptical column P3 or a virtual second elliptical column P4.

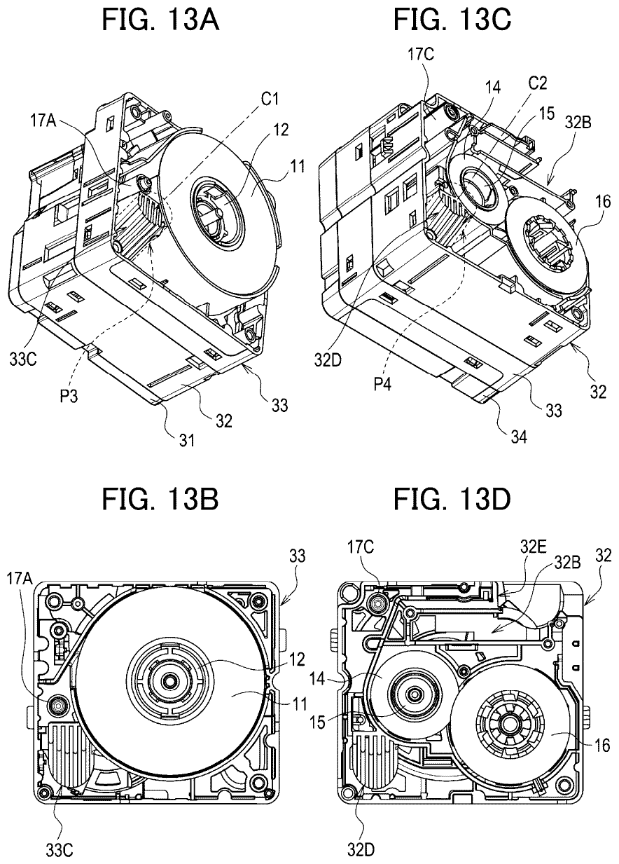

Further, as illustrated in FIGS. 13A, 13B, 13C, and 13D, the first guide surface 331 of the first guide 33C and the second guide surface 321 of the second guide 32D need not be constituted by outer circumferential surfaces of circular columns, circular cylinders, elliptical columns, or elliptical cylinders.

The first guide 33C in FIGS. 13A and 13B is configured of a plurality of ribs arranged along the outer circumferential surface of the virtual first circular column P3. Specifically, the first guide 33C is constituted by a set of endfaces of the ribs constituting a part of the outer circumferential surface of the virtual first circular column P3. The first guide 33C is thus constituted by a plurality of non-continuous surfaces. The central axis C1 of the virtual first circular column P3 corresponds to the central axis C1 of the first guide 33C in FIG. 8A.

The second guide 32D in FIGS. 13C and 13D is configured of a plurality of ribs arranged along the outer circumferential surface of the virtual second circular column P4. Specifically, the second guide 32D is constituted by a set of endfaces of the ribs constituting a part of the outer circumferential surface of the virtual second circular column P4. The second guide 32D is thus constituted by a plurality of non-continuous surfaces. The central axis C2 of the virtual second circular column P4 corresponds to the central axis C2 of the second guide 32D in FIG. 8A.
(3b) In the printing device of the above embodiments, the first width direction need not be parallel to the second width direction. Further, the central axis of the first guide (i.e., the first circular column or first elliptical column) need not be parallel to the first virtual plane, and need not be inclined relative to the first width direction. Further, the central axis of the second guide (i.e., the second circular column or second elliptical column) need not be parallel to the second virtual plane, and need not be inclined relative to the second width direction.
(3c) The printing device in the above-described embodiments need not be a device configured to perform printing with an ink ribbon. For example, the printing device may perform printing on a strip-like thermal paper. That is, the printing cassette need not include an ink ribbon.

Further, the printing device may also employ stencil tapes as a printing tape, whereby a printing pattern is perforated in the stencil tape by a thermal head. In a case where a stencil tape is used as the printing tape, a laminating tape for protecting the stencil tape is to be used as an auxiliary tape instead of the ink ribbon.
(3d) In the printing cassette of the above embodiments, the main case may include a fifth guide that is provided between the first guide and second guide and that contacts the printing tape. The fifth guide may be fixed to the body of the main case, or may be rotatable about an axis thereof relative to the body of the main case.
(3e) In the printing cassette of the above embodiments, the drive transmission mechanism may be disposed upward of the printing tape roll, or downward of the conveying path of the printing tape. Further, the printing cassette need not include the drive transmission mechanism.
(3f) The functions possessed by a single component in the embodiments described above may be distributed among a plurality of components, and the functions possessed by a plurality of components may be integrated into a single component. Further, a part of the configurations in the above-described embodiments may be omitted. Further, at least a part of the configurations in the described embodiments may be added to or replaced in configurations in other embodiments. Incidentally, every aspect included in the technical concepts that can be identified from the recitations in the claims is the embodiments of the present disclosure.

What is claimed is:

1. A printing cassette comprising:
a tape roll including a tape to be used for printing, the tape being wound about an axis parallel to a first direction; and
a case that accommodates the tape roll therein,
wherein the case has:
a first guide, at least a part of the first guide being arranged at the same position as the tape roll in the first direction, the first guide being configured to guide the tape drawn off the tape roll to alter both a first component and a second component of a conveying direction of the tape, the first component being parallel to the first direction and the second component being orthogonal to the first direction; and
a second guide arranged at a different position from the tape roll in the first direction, the second guide being configured to guide the tape guided by the first guide to alter both the first component and the second component of the conveying direction,
wherein the first guide has a first guide surface whose shape is defined by a part of an outer circumferential surface of a virtual first circular column or a virtual first elliptical column each having a first central axis inclined relative to the first direction,
wherein the second guide has a second guide surface whose shape is defined by a part of an outer circumferential surface of a virtual second circular column or a virtual second elliptical column each having a second central axis inclined relative to the first direction, and
wherein the second central axis is not on the same virtual plane as the first central axis is.

2. The printing cassette according to claim 1,
wherein the first central axis is inclined to extend away from the axis of the tape roll as approaching the second guide in the first direction.

3. The printing cassette according to claim 1,
wherein the second central axis is inclined to extend away from the axis of the tape roll as approaching the first guide in the first direction.

4. The printing cassette according to claim 1,
wherein the case further has a third guide configured to guide the tape drawn off the tape roll to alter the second component of the conveying direction, at least a part of the third guide being arranged at the same position as the tape roll in the first direction,
wherein the third guide has a third guide surface whose shape is defined by a part of an outer circumferential surface of a virtual third circular column or a virtual third elliptical column each having a third central axis parallel to the first direction, and
wherein the first guide is configured to guide the tape guided by the third guide.

5. The printing cassette according to claim 4,
wherein the case has a fourth guide arranged at a different position from the tape roll in the first direction, the fourth guide being configured to guide the tape guided by the second guide to alter the second component of the conveying direction, and
wherein the fourth guide has a fourth guide surface whose shape is defined by a part of an outer circumferential surface of a virtual fourth circular column or a virtual fourth elliptical column each having a fourth central axis parallel to the first direction.

6. The printing cassette according to claim 5,
wherein a first width direction of the tape in a first region between the third guide and the first guide and a second width direction of the tape in a second region between the second guide and the fourth guide are parallel to each other.

7. The printing cassette according to claim 6,
wherein a first conveying direction of the tape in the first region and a second conveying direction of the tape in the second region are parallel to each other.

8. The printing cassette according to claim 7,
wherein the first conveying direction and the second conveying direction are both orthogonal to the first direction.

9. The printing cassette according to claim 6,
wherein the first central axis is parallel to a first virtual plane including both the first width direction and a first conveying direction of the tape in the first region, the first central axis being inclined relative to the first width direction, and
wherein the second central axis is parallel to a second virtual plane including both the second width direction and a second conveying direction of the tape in the second region, the second central axis being inclined relative to the second width direction.

10. The printing cassette according to claim 4,
wherein a third conveying direction of the tape in a region between the tape roll and the third guide is orthogonal to the first direction.

11. The printing cassette according to claim 5,
wherein the case has a drawn-out part arranged at the same position as the second guide in the first direction, the tape guided by the second guide being configured to be drawn out from inside toward outside of the case through the drawn-out part, and
wherein a fourth conveying direction of the tape in a region between the fourth guide and the drawn-out part is orthogonal to the first direction.

12. The printing cassette according to claim 6,
wherein, when viewed in the first direction, a turning angle of a second conveying direction of the tape in the second region relative to a first conveying direction of the tape in the first region is no greater than 195 degrees.

13. The printing cassette according to claim 6,
wherein a sum of a winding angle of the tape over the first guide surface in a circumferential direction of the virtual first circular column or the virtual first elliptical column and a winding angle of the tape over the second guide surface in a circumferential direction of the virtual second circular column or the virtual second elliptical column is 235 degrees or less.

14. The printing cassette according to claim 1,
wherein the case has a case body that supports the first guide and the second guide, and
wherein the first guide or the second guide is rotatable about an axis thereof relative to the case body.

15. The printing cassette according to claim 1,
wherein the case has a case body that supports the first guide and the second guide, and
wherein the first guide or the second guide is fixed to the case body.

16. The printing cassette according to claim 1,
wherein the tape does not contact the case between the first guide and the second guide.

17. The printing cassette according to claim 1,
wherein the case has a fifth guide arranged between the first guide and the second guide and contacting the tape.

18. The printing cassette according to claim 1,
wherein the case has a rectangular outer shape when viewed in the first direction, and
wherein the first guide and the second guide are respectively arranged at different corner portions of the case.

19. The printing cassette according to claim 1, further comprising an auxiliary tape roll including an ink ribbon to be used for printing, the ink ribbon being wound, the auxiliary tape roll being arranged at the same position as the second guide in the first direction.

20. The printing cassette according to claim 1,
wherein the case has a drawn-out part arranged at the same position as the second guide in the first direction, the tape guided by the second guide being to be drawn out from inside to outside of the case through the drawn-out part.

21. The printing cassette according to claim 20,
wherein the tape drawn out through the drawn-out part faces a print head of a printing device body in a state where the case is attached to the printing device body.
